(19) United States
(12) Patent Application Publication
(10) Pub. No.: US 2007/0109088 A1
(43) Pub. Date: May 17, 2007

(54) Snap-On Parasitic Power Line Transformer

(75) Inventors: Bernt Askild Askildsen, Rapid City, SD (US); Scott Randall Thompson, Hermosa, SD (US)

Correspondence Address: REALTRONICS CORPORATION, 322 CANAL STREET, RAPID CITY, SD, 57701-2680, US

(73) Assignee: REALTRONICS/EDGECOM, Rapid City, SD (US)

(21) Appl. No.: 11/164,158

(22) Filed: Nov. 11, 2005

(51) Int. Cl. H01F 27/24

(52) U.S. Cl. 336/212

(57) ABSTRACT

An economically attractive method to tap low-level electric power from any power line is disclosed. The invention captures power for low consumption electronic components such as communication repeaters and remote sensors. The device snaps onto any power line and functions as a parasitic current transformer. It captures the dynamic magnetic energy that is created by electric current as it flows through the power line and concentrates the resulting magnetic flux into a region where the energy is converted to electricity in a pick-up coil. The difference between the disclosed device and a conventional transformer is that the magnetic flux that is set up in the low-reluctance material of the former originates from alternating current on a power line phase and not from a primary transformer winding as in the latter.

### CROSS-REFERENCE TO RELATED APPLICATIONS

Current US Class: 323/358, 363/15, 307/150

Intern'l Class: H01F 32/28

Field of Search: 307/1-9, 91, 150, 323/6, 358, 336/173, 363/15

### BACKGROUND OF THE INVENTION

This disclosure describes a low-cost, low-power, step-down transformer that clamps directly to a power line and is intended to supply electricity to electronic devices such as remote sensors and communication repeaters. This invention improves on the most commonly used source of electricity along the power grid, the common two-phase transformer, which is accompanied by high startup and residual costs that are often prohibitively expensive for low power consumption applications like those mentioned above. Moreover, electric power from the power grid is sporadically plagued by lightning strikes that can damage susceptible electronics like those that are found in a sensor or communication network. The seemingly viable alternative of solar energy is also plagued by size and cost factors that limit widespread use of ubiquitous sensor and communication networks; particularly in remote areas. Solar cells, also known as photovoltaics, require large panels to generate relatively amounts of energy and are generally accompanied by heavy, low-energy density, lead acid batteries that can withstand frequent charge cycles.

Electric power conversion systems date back to the latter part of the 1800's including two electric power conversion and distribution systems that were disclosed in 1888 under U.S. Pat. No. 383,620 and in 1981 under U.S. Pat. No. 461,139. Several domestic and international patents related to power conversion and distribution were filed since that time including one by Yokohama et. al., U.S. Pat. No. 3,515,890, which closely parallels the design of most power line transformers that are in use today. In 1972 Anderson was granted U.S. Pat. No. 3,701,003, which describes a current transformer with an improved coaxial feed that was designed to obtain more accurate current flow measurements. In 1977 U.S. Pat. No. 4,024,410 was issued to Mr. Dahlberg for an alternating current energy converter that uses several switches to convert the electric energy. Beattie disclosed a direct current step-down transformer in 1982 under U.S. Pat. No. 4,363,975. Beattie's device converts AC power from high voltage transmission lines into direct current that must be provided to a load that is isolated from ground and is at or near the transmission line. Halder patented a more advanced current transformer in 1985 to support measuring instruments; this disclosure improved on the prior art that was disclosed by Mr. Anderson in U.S. Pat. No. 3,701,003.

Some of the more current prior art focuses on incremental improvements to the conventional power line transformer. An example of this is cited in U.S. Pat. No. 6,028,422, which discloses an AC transformer comprised of at least one transformer core with a primary winding and at least one secondary winding that is connected in parallel to the primary winding and is terminated by a low-impedance load. A similar example is cited in U.S. Pat. No. 6,021,499, which discloses an isolated ground reference DC power supply that shows some of the benefits of an isolated ground reference. A device that is disclosed under U.S. Pat. No. 6,188,146 employs energy cells to capture light from a nearby source, including a street light, and convert this energy into electricity for low-power applications including communication repeaters.

Like the foregoing, prior art fails to describe a specific solution that affords the capability of tapping magnetic energy from a single power line by guiding flux that is produced by electric flow through line same into a low reluctance channel. The advantage of the approach that is disclosed herein is that it provides a low-cost means of concentrating and subsequently converting this magnetic flux into a low-voltage source of electricity. An additional benefit of the disclosed invention is that it provides an isolated reference to common ground, which protects the device and any electrical load on the device from the damaging effects of lightning and other energy spikes. This invention also overcomes the effects of over-voltage on the secondary side of the transformer by employing a flux channel that enters saturation when the current flow on the power line reaches levels that would otherwise overburden the load side of the transformer.

### BRIEF SUMMARY OF THE INVENTION

This invention discloses a low-cost device that captures and converts the magnetic flux that surrounds any current carrying conductor and in particular the high voltage power lines that makeup the power grid into an ancillary source of low-voltage power. The device capitalizes on the circular dynamic magnetic field that is set up by the current that flows through any power line. A low-reluctance metallic core with a specific geometry captures this flux over a large area and subsequently channels this energy through a narrow funnel that concentrates the magnetic flux, φ. Transformer windings are wrapped around the magnetic flux funnel to convert the magnetic energy to usable low-voltage electric power that can energize electronic device such as a communication repeaters and ubiquitous remote sensors. The transformer and any supporting components are enclosed in an all-weather housing that is easily clamped or snapped directly onto the power line. The enclosure may also house remote sensors, communication repeaters, and other components that are energized by the disclosed device.

### BRIEF DESCRIPTION OF THE DRAWING

The below listed figures illustrate the disclosed invention and how it can be designed, assembled and installed. These drawings show how to build a sample embodiment of the disclosed invention and are not intended to limit the spirit or scope of this invention. The sprit of this invention encompasses any device that employs a metallic core that is placed in close proximity to the circular lines of magnetic flux along a single power line; provided that the metallic material includes any geometry that funnels the magnetic flux into an area of high concentration where a pick-up coil is placed to capture and convert the same into electricity.

FIG. 1: Is an illustration of a metallic low-reluctance channel.

FIG. 2: Shows a coil that is placed over a high flux area on a low-reluctance channel.

FIG. 3: Illustrates an embodiment of the disclosed invention in an all-weather housing.

FIG. 4: Shows the low-reluctance device, coil windings, transformer, and electronics.

FIG. 5: Is an expanded view of an embodiment of this invention.

FIG. 6: Shows an embodiment of this invention that is mounted to a power line.

### DETAILED DESCRIPTION OF THE INVENTION

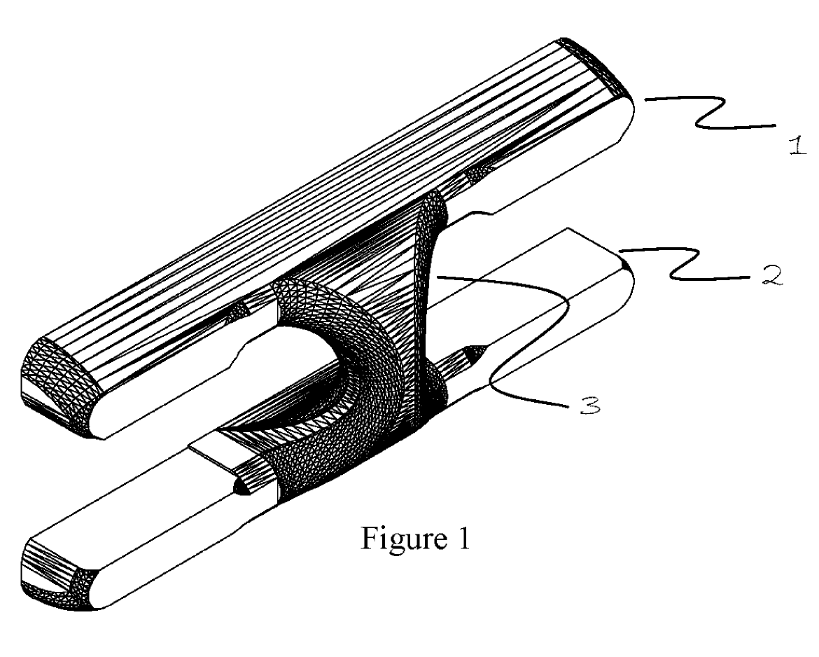

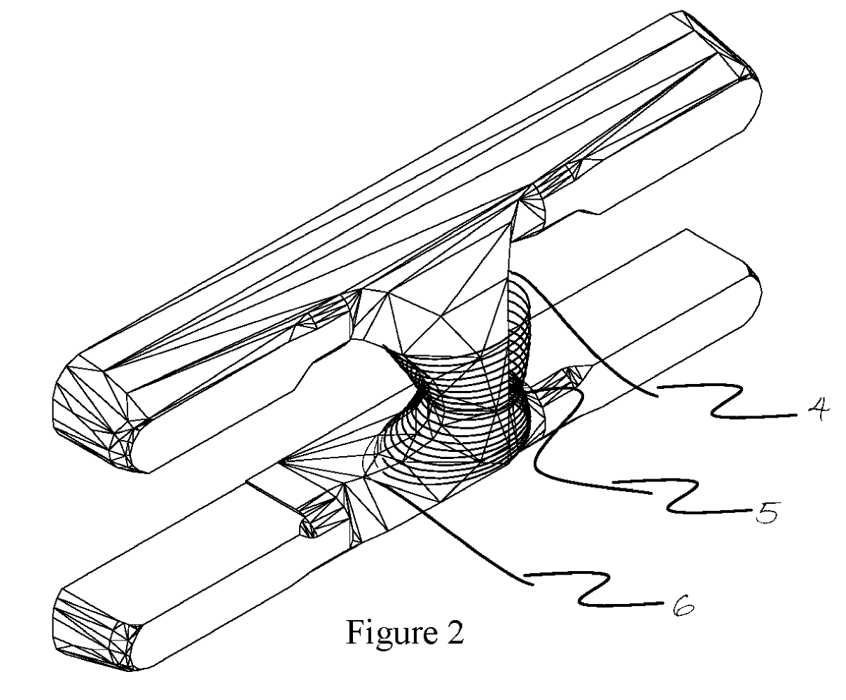

This invention disclosure describes a voltage step-down transformer that works by capturing and converting magnetic energy along an active power line into low-voltage electricity. An embodiment of this invention is shown in FIG. 1. Here the circular magnetic flux that is generated by the current in the power line is attracted to the low-reluctance path that originates at points 1 or 2 on the metallic core; the path origin along the core is a factor of the direction of current flow in the power line. The magnetic energy follows the geometry of the core into the concentrated area at 3 as magnetic flux flows between the broad panels that are shown on either side of the core. The forced flow of high-density magnetic flux through the metallic core induces an electric current in the pick-up coil that is shown in FIG. 2. The direction of current flow between 4 and 6 in this figure follows that of the right-hand rule. A rectifier can be connected between 4 and 6 and a center tap can be inserted at 5 to provide a floating ground reference. Any standard method can be applied to rectify and condition the alternating current energy picked up in the coil. Additional conditioning circuitry including charge cells and rechargeable batteries can be used to enhance the performance of the disclosed invention without deviating from the spirit or scope of the same.

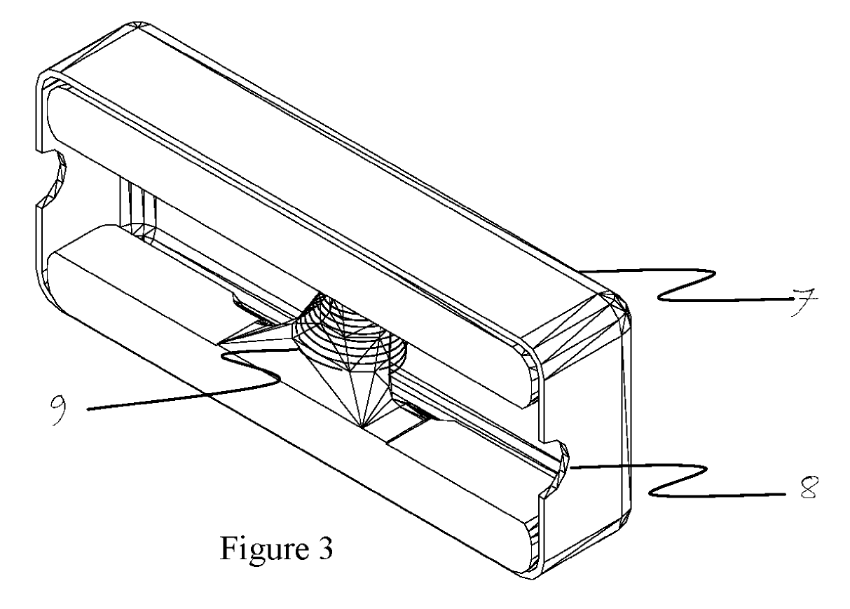

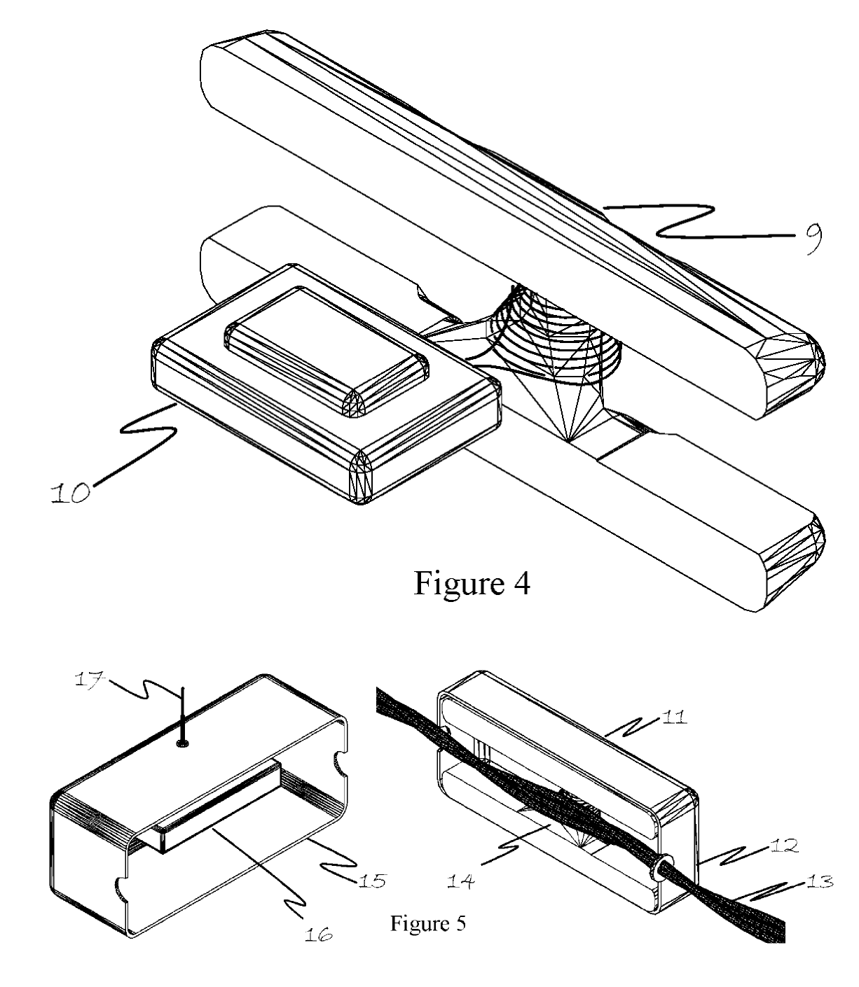

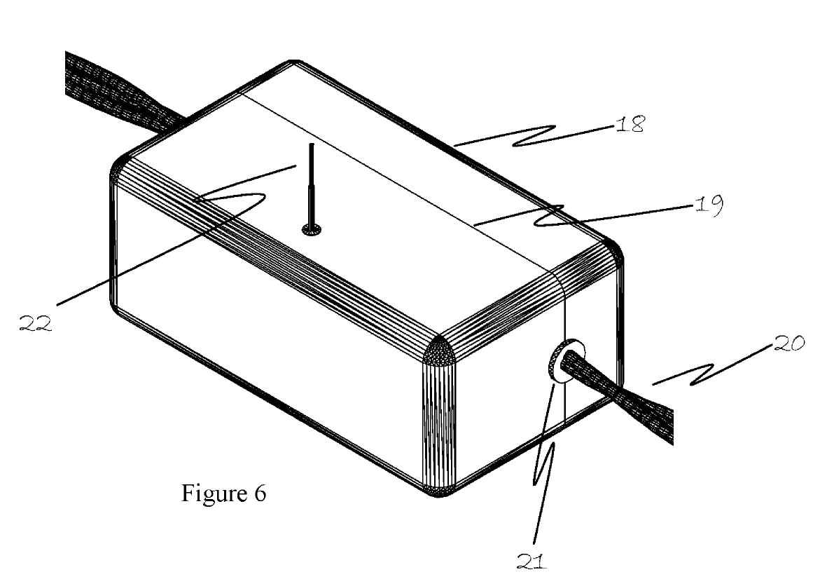

An optimal embodiment of this invention is to house the individual components of the device into a weather proof housing and to immerse the coil wire into a thick electric insulator to obtain sufficient galvanic isolation between the power line voltage and the low voltage circuitry. An example of this type of embodiment is illustrated in FIG. 3, which shows one half of the transformer; FIG. 4, which shows individual components including an all weather housing 7, holes in the all weather housing to accommodate the power line 8, a ferric magnetic core 9, and an enclosure to isolate sensitive electronics from the power line 10; FIG. 5, which depicts the device 11, the mounting area 12, the power line 13, an all-weather housing 15, shielded interior electronic components 16, and an antenna that may be used for communication repeater hardware 17; and FIG. 6, which shows the device once it has been mounted to a power line. The components of the disclosed embodiment of this invention in FIG. 6 include the all weather housing shown at 18 and 19, the power line 20, a water proof fitting around the power line 21, and a communication repeater antenna 22.

What is claimed is:

1. Any device that snaps onto any high voltage power line on any current carrying phase of any type of power grid that converts any portion of the magnetic energy near the power line into electric energy to form a voltage step-down transformer that comprises in combination,
any plurality of any type of low-reluctance material of any geometry that is used to concentrate magnetic flux into any plurality of high density regions,
any plurality of coil wire windings wrapped around the reluctance material in any plurality of high density magnetic flux regions,
any combination of line conditioning electronics,
any combination of voltage rectifying electronics,
any combination of power back up or battery type storage and circuitry that supports the same,
any plurality of coils that are configured to support a floating ground that isolates the device and any load on the device from lightning surges or power line voltage transients,
any type of all-weather housing to protect the components that comprise the device,
any type of seal or sealant to prevent moisture from entering the device through any connection around the power line.

2. Any device of the type in claim 1 that employs magnetic saturation schemes to protect the coil wire windings from damage that is caused by lighting or high current flow through the power line.

3. Any device of the type in claim 1 that uses any type of insulation material to electrically and physically isolate any components of the transformer from the power line.
